(19) United States
(12) Patent Application Publication
(10) Pub. No.: US 2009/0284120 A1
(43) Pub. Date: Nov. 19, 2009

(54) ELECTRON EMITTER AND IMAGE DISPLAY APPARATUS

(75) Inventors: Koki Nukanobu, Machida-shi (JP); Takahiro Sato, Ebina-shi (JP); Takuto Moriguchi, Chigasaki-shi (JP); Eiji Takeuchi, Atsugi-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/430,580

(22) Filed: Apr. 27, 2009

(30) Foreign Application Priority Data
May 14, 2008 (JP) 2008-126627

(51) Int. Cl. H01J 1/02

(52) U.S. Cl. 313/235

(57) ABSTRACT

An electron emitter retaining a stable electron emission property with minimized fluctuation over a long period of time is provided. Also, a long-life image display apparatus that exhibits little fluctuation over a long period of time, by using electron emitters that retain a stable electron emission property with minimized fluctuation over long period of time is provided.

### BACKGROUND OF THE INVENTION

1. Field of the Invention

The present invention relates to an electron emitter and an image display apparatus using the electron emitter.

2. Description of the Related Art

There are electron emitters such as field-emission electron emitters and surface-conduction electron emitters. FIGS. 20 and 21 schematically show an existing surface-conduction electron emitter and a process for fabricating the surface-conduction electron emitter.

In an existing surface-conduction electron emitter fabrication process, first a pair of electrodes are provided on an insulating substrate. Then, the pair of electrodes are interconnected by a conductive film. A voltage is applied across the electrodes to form a first gap in a part of the conduction film, which process is called “energization forming”. In the energization forming process, a current is passed through the conductive film to generate Joule heat and the Joule heat is used to form a first gap in a part of the conductive film 4. As a result of the energization forming process, a pair of conductive films are formed that are opposed to each other with the first gap between them. Then a process called “activation” is applied. In the activation process, a voltage is applied across the pair of the electrodes in an atmosphere of a gas containing carbon. By the process, a conductive carbon film can be provided on the surface of the substrate in the first gap and on the conductive film in the vicinity of the first gap. Thus, an electron emitter is formed.

To cause the electron emitter to emit electrons, a higher electric potential is applied to one of the electrodes and a lower electric potential is applied to the other. By applying voltage across the electrodes in this way, a strong electric field is generated in a second gap. As a result, electrons tunnel through many portions (a plurality of electron emission portions) at the edge of the carbon film that connects to the low-potential electrode and forms an outer edge of the second gap, and thus some of the tunneled electrons are emitted.

Japanese Patent No. 2627620, Japanese Patent Application Laid-Open Nos. 2002-352699 and 2004-055347 disclose techniques that control the shape of a conductive film or divide a conductive film into multiple sections, thereby minimizing variations among first gaps during a energization forming process, discharge breakdown in electron emission portions during an activation process, or breakage of electron emission portions due to ion bombardment during driving.

An image display apparatus can be fabricated by arranging multiple electron emitters described above to form an electron source on a substrate, the substrate opposing to another substrate having a light-emitting film made of a phosphor material, and maintaining the space between the substrates under vacuum.

Image display apparatuses in these years are required to be capable of stably displaying a display image with minimum variations in brightness over a long period of time. Therefore, in an image display apparatus having an electron source in which multiple electron emitters are arranged, each electron emitter needs to retain good properties with minimum variations over a long period of time.

However, when an existing surface-conduction electron emitter is driven, fluctuations in electron emission (a phenomenon in which electron emission current fluctuates for a short time) occur if the sheet resistance of the conductive film 4 is low.

As described above, it is considered that electrons tunnel through many portions that are part of the edge of one of the carbon films and form an outer edge of the gap. For example, when one of the electrodes is driven to a higher electric potential than the other, the carbon film connecting to the other electrode through the conductive film functions as an emitter. As a result, there are probably many electron emission portions in a region at the edge of the carbon film that forms the outer edge of the second gap. That is, it is considered that there are many electron emission portions along the second gap at the edge of the carbon film connecting to the electrode to which a low electric potential is applied and the individual electron emission portions are electrically interconnected with a resistance value of the carbon film. Therefore, even if a conductive film having a higher sheet resistance than that of the carbon film is provided, fluctuations in electron emission cannot sufficiently be minimized due to the resistance of interconnection of electron emission portions arranged at the edge of the carbon film.

Consequently, in the electron source in which many electron emitters are arranged, electron emission fluctuations are caused possibly by a low resistance of the conductive film or the resistance of interconnection between electron emission portions by the carbon film. In an image display apparatus using the electron emitters described above, variations in brightness between adjacent pixels and fluctuations in brightness sometimes occur which are likely to be caused by fluctuations in electron emission described above. Therefore, it is difficult to provide a high-resolution and high-image-quality display images.

### SUMMARY OF THE INVENTION

Therefore, an object of the present invention is to provide an electron emitter retaining a stable electron emission property with minimized fluctuation over a long period of time.

Another object of the present invention is to provide a long-life image display apparatus that exhibits little fluctuation over a long period of time, by using electron emitters that retain a stable electron emission property with minimized fluctuation over long period of time.

According to the present invention, there is provided an electron emitter including: at least one pair of electrodes formed on an insulating substrate and a plurality of conductive films formed to interconnect the electrodes, wherein each of the conductive films has a gap between the electrodes; the distance L1 between the electrodes and the width W1 of the conductive film in the direction orthogonal to the direction in which the electrodes are opposed to each other are such that W1/L1≦0.18; and the sheet resistance of the conductive film is in the range from 1×10² to 1×10⁷Ω/□.

According to the present invention, there is also provided an electron emitter including: at least one pair of electrodes formed on an insulating substrate and a conductive film formed to interconnect the electrodes, wherein the conductive film has a plurality of openings between the electrodes in the direction orthogonal to the direction in which the electrodes are opposed to each other and has a gap in a region in the conductive film along the direction orthogonal to the direction in which the electrodes are opposed to each other, the region is adjacent to the openings; the distance L2 between the electrodes and the width W1 of the conductive film adjacent to the opening in the direction orthogonal to the direction in which the electrodes are opposed to each other are such that W1/L2≦0.18; and the sheet resistance of the conductive film is in the range from 1×10² to 1×10⁷Ω/□.

Further features of the present invention will become apparent from the following description of the exemplary embodiments with reference to the attached drawings.

### BRIEF DESCRIPTION OF THE DRAWINGS

FIGS. 1A, 1B and 1C are diagrams schematically illustrating an exemplary configuration of a first electron emitter according to the present invention.

FIGS. 2A, 2B and 2C are diagrams schematically illustrating a process for fabricating the electron emitter shown in FIGS. 1A, 1B, and 1C.

FIGS. 3A, 3B and 3C, are diagrams schematically illustrating an exemplary configuration of a second electron emitter according to the present invention.

FIGS. 4A, 4B and 4C are diagram schematically illustrating another exemplary configuration of the first electron emitter according to the present invention.

FIGS. 5A, 5B and 5C are schematic diagrams illustrating a process for fabricating the electron emitter shown in FIGS. 4A, 4B and 4C.

FIG. 6 is a schematic diagram illustrating an example of a pulse applied during a forming process for an electron emitter according to the present invention.

FIG. 7 is a schematic diagram illustrating an example of a pulse applied during an activation process for an electron emitter according to the present invention.

FIG. 8 is a schematic diagram illustrating a configuration of a display panel using an electron emitter according to the present invention.

FIG. 9 is a graph of emission current fluctuation versus WI/L1 in Example 1 of the present invention.

FIG. 10 is a graph of emission current versus sheet resistance of a conductive film in Example 2 of the present invention.

FIG. 11 is a graph of emission current fluctuation versus WI/(L3+L4) in Example 5 of the present invention.

FIG. 12 is a graph of emission current fluctuation versus sheet resistance of a conductive film in Example 6 of the present invention.

FIGS. 13A, 13B, 13C, 13D and 13E are schematic plan views illustrating a process for fabricating an electron source according to Example 7 of the present invention.

### DESCRIPTION OF THE EMBODIMENTS

According to a first aspect of the present invention, there is provided an electron emitter including: at least one pair of electrodes formed on an insulating substrate and a plurality of conductive films formed to interconnect the electrodes, wherein each of the conductive films has a gap between the electrodes; the distance L1 between the electrodes and the width W1 of the conductive film in the direction orthogonal to the direction in which the electrodes are opposed to each other are such that W1/L1≦0.18; and the sheet resistance of the conductive film is in the range from 1×10² to 1×10⁷Ω/□.

According to a second aspect of the present invention, there is provided an electron emitter including: at least one pair of electrodes formed on an insulating substrate and a conductive film formed to interconnect the electrodes, wherein the conductive film has a plurality of openings between the electrodes in the direction orthogonal to the direction in which the electrodes are opposed to each other and has a gap in a region in the conductive film along the direction orthogonal to the direction in which the electrodes are opposed to each other, the region is adjacent to the openings; the distance L2 between the electrodes and the width W1 of the conductive film adjacent to the opening in the direction orthogonal to the direction in which the electrodes are opposed to each other are such that W1/L2≦0.18; and the sheet resistance of the conductive film is in the range from 1×10² to 1×10⁷Ω/□.

According to a third aspect of the present invention, there is provided an image display apparatus including: a first substrate on which a plurality of electron emitters according to the present invention is disposed; and a second substrate which is opposed to the first substrate and on which an image display member to which electrons emitted from the plurality of electron emitters are irradiated is disposed so as to face the electron emitters.

According to the present invention, a good electron emission property can be retained over a long period of time. Consequently, an image display apparatus capable of displaying a high-definition display image with minimized fluctuation in brightness can be provided.

An electron emitter and a method for fabricating the electron emitter according to the present invention will be described below. However, specific materials and numeric values given in the following description are illustrative only. Any of various other materials and numeric values that are suited for applications of the present invention can be used within a scope in which the objects and effects of the present invention can be achieved.

Various embodiments of an electron emitter according to the present invention will be described below.

### First Embodiment

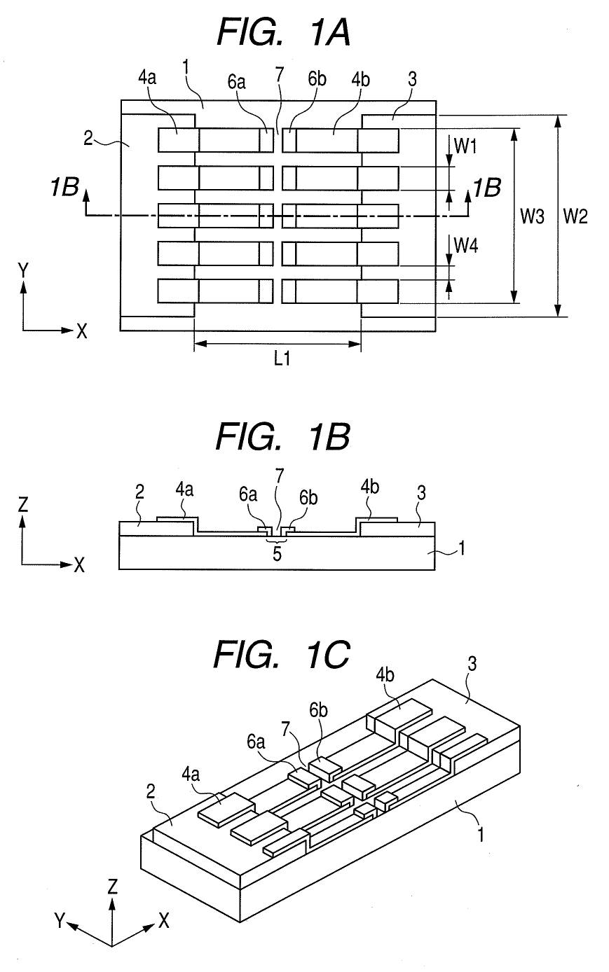

A basic configuration of a first electron emitter of the present invention according to the most typical embodiment will be described first with reference to FIGS. 1A, 1B, and 1C. FIG. 1A is a schematic plan view illustrating a typical configuration according to the embodiment; FIG. 1B is a schematic cross-sectional view of the configuration taken along line 1B-1B in FIG. 1A; and FIG. 1C is a perspective view of the configuration taken along line 1B-1B in FIG. 1A.

As described herein, the X-direction is the direction in which electrodes 2, 3 are opposed to each other, the Y-direction is the direction orthogonal to the X-direction, and the Z-direction is the direction of the normal to the substrate 1.

Electrodes 2 and 3 are disposed on an insulating substrate 1 a distance L1 apart from each other. A conductive film 4a interconnects the electrodes 2 and a carbon film 6a. A conductive film 4b interconnects the electrodes 3 and a carbon film 6b. The conductive films 4a and 4b are opposed to each other with a first gap 5 between them. The carbon films 6a and 6b are opposed to each other with a second gap 7 between them. Multiple sets of such conductive film 4a, carbon film 6a, conductive film 4b, and carbon film 6b are disposed at the pair of electrodes 2 and 3.

The width of the gap 7 is set to a value between or equal to 1 nm and 10 nm in practice in order to keep driving voltage at a value less than or equal to 30 V with consideration given to the cost of the driver and to prevent electric discharge caused by an unexpected voltage variation during driving.

The carbon films 6a and 6b are shown as two completely separated films in FIGS. 1A, 1B, and 1C. However, the gap 7 and the carbon films 6a and 6b can be collectively referred to as a “carbon film including a gap” because the gap 7 is very small as described above. Accordingly, the electron emitter of the present invention can be referred to as an electron emitter that emits electrons when a voltage is applied across one end of a carbon film including a gap and the other end in order to drive the electron emitter.

The carbon films 6a and 6b can be united with each other in a very small region. If the region is very small, it is permissible because the region will have a high resistance and therefore the influence of the region on the electron emission property is limited. Such an implementation in which the carbon films 6a and 6b are partially united may be referred to as a “carbon film including a gap”.

The gap 7 in the example in FIG. 1A is linear in shape. Although the gap 7 is preferably linear in shape, the shape of the gap 7 is not limited to a linear shape. The gap may have any shape such as a shape bending with a certain periodicity, an arc shape, or a combination of an arc and line.

The gap 7 is formed by an edge (outer edge) of the carbon film 6a and an edge (outer edge) of the carbon film 6b that are opposed to each other.

For example, when an electric potential higher than the electric potential applied to the electrode 2 is applied to the electrode 3 in order to drive (to cause electron emission) the electron emitter, it is likely that there are many electron emission portions in a part of an edge of the carbon film 6a that forms an outer edge of the gap 7. The carbon film 6a connecting to the electrode 2 can be considered as acting as an emitter. That is, it is likely that there are many electron emission portions in a part of an edge of the carbon film 6a that forms an outer edge of the gap 7.

The gap 7 can be formed by applying any of various nano-scale high-precision processing methods such as the FIB (Focused Ion Beam) method to a conductive film. Therefore, the gap 7 of the electron emitter of the present invention is not limited to the gap 7 formed by an “energization forming” process and an “activation” process, which will be described later. The gaps 7 may be any gap that electrically isolates the multiple conductive films from each other.

The carbon films 6a, 6b adjacent to each other in the Y-direction are electrically independent of each other. Similarly, conductive films 4a, 4b adjacent to each other in the Y-direction are electrically independent of each other.

In the region where the multiple carbon films 6a, 6b and the conductive films 4a, 4b are not formed, an activation inhibiting layer (not shown) is formed in contact with each of the films. The activation inhibiting layer is provided preferably if the gap 7, where there are many electron emission portions, is formed by the activation process, which will be described later. This is because in the absence of the activation inhibiting layer, the carbon films 6a, 6b will be deposited over a wide area on the substrate 1 and adjacent conductive films will become electrically shorted if the substrate 1 is predominantly composed of an activation accelerating material (SiO₂).

If the gaps 7 are formed by applying any of various nano-scale high-precision processing methods such as FIB to the conductive films, that is, the activation process is not used, the activation prohibiting layer may be omitted.

With the configuration described above, fluctuations in electron emission can be minimized.

The conductive films 4a, 4b may be made of a conductive material such as metal or semiconductor. For example, a metal such as Pd, Ni, Cr, Au, Ag, Mo, W, Pt, Ti, Al, Cu, or Pd or an oxide of any of these metals, or an alloy of any of these metals, or a carbon.

The conductive films 4a, 4b are formed so as to have a sheet resistance value Rs in the range from 1×10² to 1×10⁷Ω/□ in order to achieve minimization of fluctuations in electron emission, which is an effect of the present invention. The thickness of the film that exhibits a resistance value in this range is preferably between or equal to 5 nm and 100 nm. The sheet resistance Rs is a value that appears in the equation R=Rs(l/w), where R is the resistance of the film having a thickness t, a width w, and a length l, measured in the direction of the length of the film, and Rs=ρ/t, where ρ is the specific resistance of the film. The width W3 of the region over which the conductive films 4a, 4b are formed is preferably smaller than the width W2 of the electrodes 2, 3 (See FIG. 1A).

The distance L1 in the direction in which the electrodes 2 and 3 are opposed to each other (the X-direction) and the film thickness of each electrode are designed appropriately according to applications of the electron emitters. For example, if the electron emitters are to be used in an image display apparatus such as a television display, the distance L1 and thickness are designed according to the resolution of the television display. In particular, the pixel size of a high-definition (HD) television display needs to be small because a high resolution is required of the display. Accordingly, the distance L1 and the film thickness are designed such that a sufficient emission current Ie is obtained to provide a sufficient brightness with a limited electron emitter size.

In the present invention, in order to minimize fluctuations in electron emission, the relation between the distance L1 between the electrodes 2 and 3 and the width W1 of the conductive film in the direction (the Y-direction) orthogonal to the direction in which the electrodes are opposed to each other is such that W1/L1≦0.18. The practical distance L1 between the electrodes 2 and 3 is set to a value between or equal to 50 nm and 200 μm, preferably between or equal to 1 μm and 100 μm. Accordingly, the minimum width W1 of each conductive film 4a, 4b is preferably between or equal to 9 nm and 36 μm. The film thickness of the electrode 2, 3 is between or equal to 100 nm and 10 μm in practice.

The substrate 1 may be made of silica glass, sodalime glass, a glass substrate on which a silicon oxide (typically SiO₂) is deposited, or a glass substrate containing a reduced amount of alkaline component.

The electrodes 2, 3 may be made of a conductive material such as a metal or semiconductor. For example, the electrodes 2, 3 may be made of a metal or alloy such as Ni, Cr, Au, Mo, W, Pt, Ti, Al, Cu, or Pd or a metal or metal oxide such as Pd, Ag, Au, RuO₂, or Pd—Ag.

The activation inhibiting layer is preferably made of an oxide or nitride of a metal or semiconductor, or a mixture of these. For example, the activation inhabitation layer may be made of an oxide of W, Ti, Ni, Co, Cu, or Ge, or a nitride of Si, Al, or Ge, or a mixture of these. A practical sheet resistance of the activation inhibiting layers is preferably greater than or equal to 1×10⁴Ω/□ in order to prevent a short circuit of the electrodes 2, 3 and leak current during driving. The upper limit of the sheet resistance is not specified. However, if it is desired to enable the activation prohibiting layer to function as an antistatic film as well when the electron emitters are used in an image display apparatus, the sheet resistance is preferably less than or equal to 1×10¹¹Ω/□. The activation inhibiting layer is preferably formed only in a region where the conductive films 4a, 4b are not formed. However, the activation inhibiting layer may be formed on a conductive film before the gap 5 is formed if the activation inhibiting layer disappears or agglomerates and disperse from at least the gap 5 and its vicinity by heat during the subsequent forming and activation processes.

### Second Embodiment

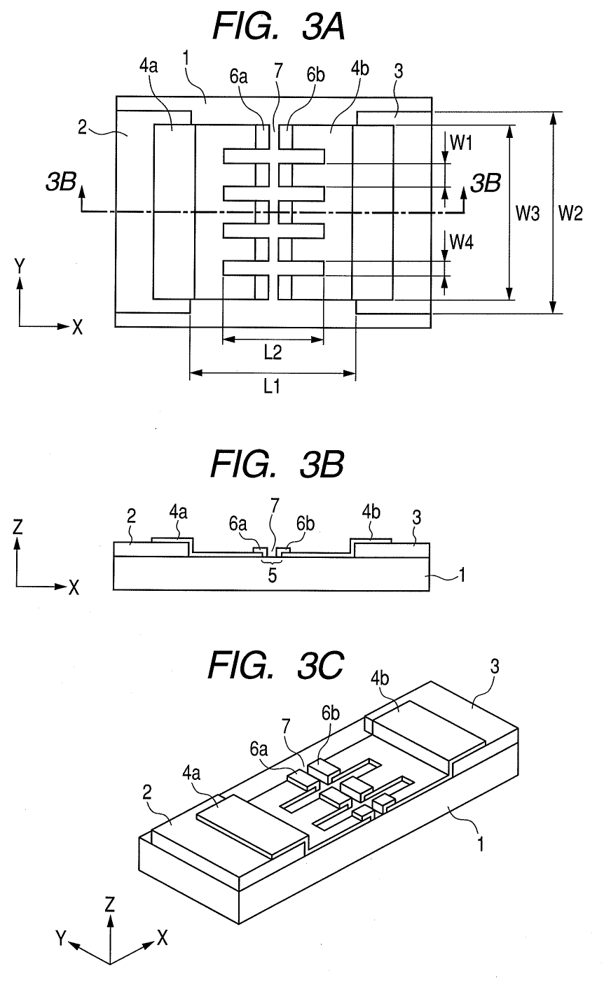

A basic configuration of an embodiment of a second electron emitter according to the present invention will be described with reference to FIGS. 3A, 3B and 3C.

FIG. 3A is a schematic plan view illustrating a configuration of the embodiment; FIG. 3B is a schematic cross-sectional view of the configuration taken along line 3B-3B in FIG. 3A; and FIG. 3C is a perspective view of the configuration taken along line 3B-3B in FIG. 3A. The same components in FIGS. 3A, 3B and 3C that are used in FIGS. 1A, 1B and 1C are labeled with the same reference numerals and symbols and the description of which will be omitted.

While multiple electrically independent conductive films 4a, 4b are provided in the first embodiment, multiple openings are provided in contiguous conductive films 4a, 4b between electrodes in the second embodiment. Multiple such openings are provided between electrodes 2, 3 in the direction (Y-direction) parallel to the direction in which the electrodes 2, 3 are opposed to each other. The openings are formed in such a manner that W1/L2≦0.18 is satisfied, where L2 is the length L2 in the X-direction of the region of the conductive films 4a, 4b that is adjacent to the openings in the Y-direction and W1 is the width of the region. A gap 7 is formed in the region of the conductive films 4a, 4b that is adjacent to the openings in the Y-direction.

### Third Embodiment

A vertical surface-conduction electron emitter has been proposed as disclosed in Japanese Patent Application Laid-Open No. 2001-143606. The present invention can be applied to those electron emitters as well.

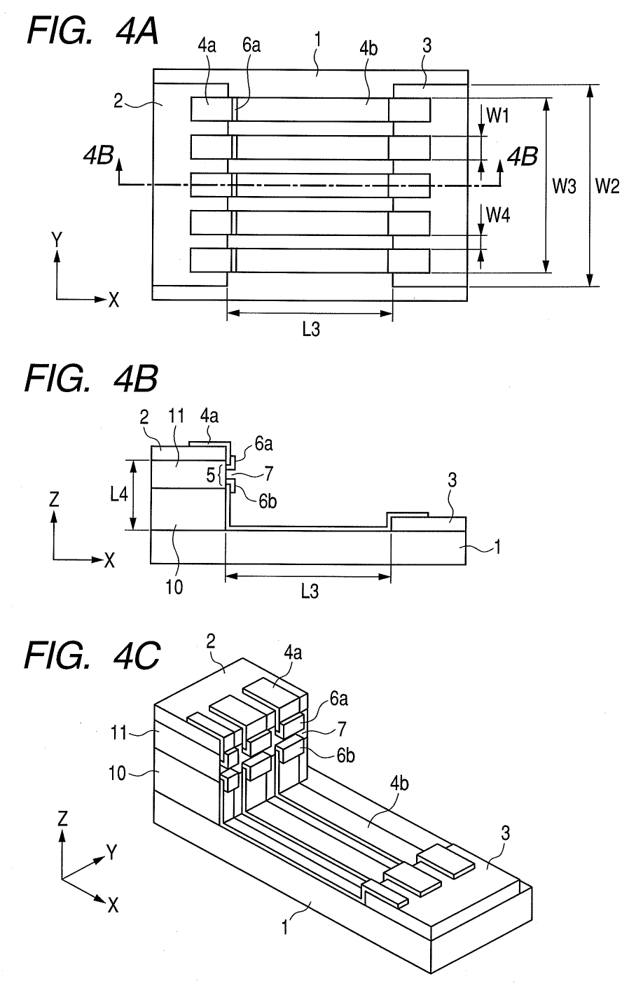

FIGS. 4A, 4B and 4C illustrate an example in which the present invention is applied to a vertical surface-conduction electron emitter. FIG. 4A is a schematic plan view illustrating a typical configuration of the example; FIG. 4B is a schematic cross-sectional view of the configuration taken along line 4B-4B in FIG. 4A; and FIG. 4C is a perspective view of the configuration taken along line 4B-4B in FIG. 4A. The same components in FIGS. 4A, 4B and 4C that are used in FIGS. 1A, 1B and 1C are labeled with the same reference numeral and symbols and the description of which will be omitted.

In the electron emitter of the example shown in FIGS. 4A, 4B and 4C, the direction in which carbon films 6a, 6b of the electron emitter that have been described with respect to the first embodiment intersects (preferably substantially perpendicular to) the surface of the substrate 1.

In the example shown, a side of a multilayer on which a second gap 7 is provided is substantially perpendicular to the surface of the substrate 1. In the first embodiment, the direction in which the carbon films 6a and 6b are opposed to each other is in the direction of the plane of the substrate 1 (the X-direction). However, it is desirable that the direction in which the carbon films 6a and 6b are opposed to each other be perpendicular to the surface of the substrate 1 (the Z-direction) in the interest of improving the electron emission efficiency (η).

In the electron emitter of the present invention, an anode electrode is provided at a distance in the Z-direction from the plane of the substrate 1 during driving.

Accordingly, the electron emission efficiency η can be increased by opposing the carbon films 6a and 6b to each other in the direction of the anode electrode. The electron emission efficiency η is a value represented as Ie/If, where Ie is the amount of electron emission and If is element current. Here, the amount of electron emission Ie is the amount of current flowing into the anode electrode and the element current If can be defined as the current flowing across the electrodes 2 and 3.

However, the side of the multilayer in the example is not limited to the direction perpendicular to the surface of the substrate 1. In practice, the angle of the side of the multilayer is preferably set to a value between or equal to 30 and 90 degrees with respect to the surface of the substrate 1.

The electric potential of the electrode 3 is set to a value higher than that of the electrode 2 during driving of the electron emitter in the example. Accordingly, the carbon film 6a connecting to the electrode 2 acts as an electron emitter during driving, as described with respect to the first embodiment.

The multilayer in which the gap 7 is provided includes an activation accelerating layer 11 and a high thermal conductive layer 10 having a higher thermal conductivity than the activation accelerating layer 11 as shown in FIGS. 4B and 4C. This is a desirable structure for forming a first gap 5 in a predetermination position (a position in the activation accelerating layer 11) during an energization forming process.

The distance L1 between the electrodes 2 and 3 in the example is equal to the sum of the distance L3 from the electrode 3 to the high thermal conductive layer 10 and the distance L4 between the substrate 1 and the electrode 2. The electrodes 2 and 3 are formed in such a manner that the length L1 and the width W1 of the conductive film 4a, 4b satisfy the relation W1/(L3+L4)≦0.18.

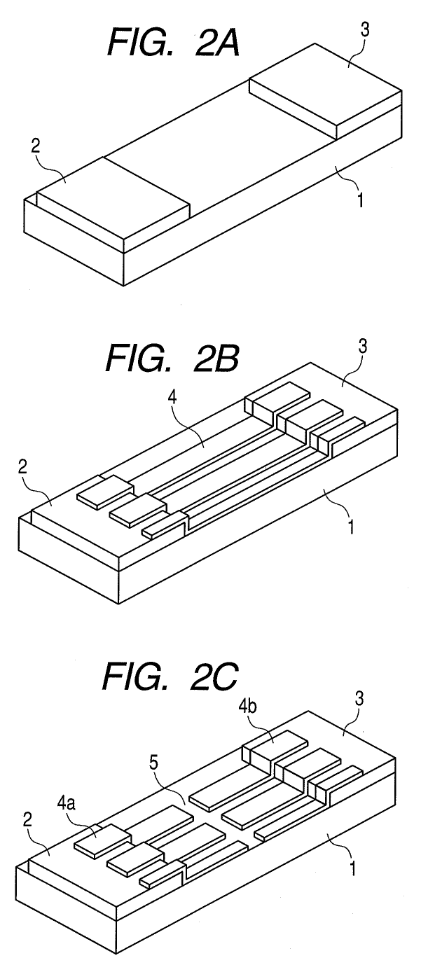

A method for fabricating an electron emitter according to the present invention will be described in detail below with respect to the electron emitter of the first embodiment by way of example. FIGS. 2A, 2B and 2C illustrate the fabrication process and are perspective views corresponding to FIG. 1C. The fabrication method according to the present invention can be performed by following the steps 1 through 5 given below, for example.

(Step 1)

A substrate 1 is adequately cleaned and a material of electrodes 2, 3 is deposited by a method such as vacuum evaporation or sputtering. Then, a technique such as photolithography is used to perform patterning to provided electrodes 2, 3 on the substrate 1 (FIG. 2A). The material and film thickness of the electrodes 2, 3 and the distance (L1) and the width (W2) may be any of the materials and values given above that are appropriately chosen.

(Step 2)

Then, multiple conductive films 4 interconnecting the electrodes 2 and 3 provided on the substrate 1 are formed (FIG. 2B).

The conductive films 4 can be formed for example as follows. First, an organometallic solution is applied and dried to form an organometallic film. The organometallic film is heated and baked to form a metal film or a metal compound film such as a metal oxide film. Then, the film is patterned by processing such as lift-off or etching to provide conductive films 4 in a predetermined pattern.

The conductive films 4 may be made of a conductive material such as a metal or semiconductor. For example, the conductive films 4 may be made of a metal such as Ni, Cr, Au, Mo, W, Pt, Ti, Al, Cu, or Pd or a metal compound (alloy or a metal oxide).

While an organometallic solution is applied in the example, the conductive film 4 formation method is not limited to this. For example, the conductive films 4 can be formed by a known method such as a vacuum evaporation, sputtering, CVD, scattering, dipping, spinner, or ink-jet method.

The conductive films 4 are formed so that the sheet resistance Rs is in the range from 1×10²Ω/□ to 1×10⁷Ω/□.

Steps 1 and 2 can be interchanged.

(Step 3)

Then an activation inhibiting layer (not shown) is formed on the substrate 1 on which the conductive films 4 have been patterned in a predetermined pattern. As has been described, the activation inhibiting layer is preferably made of an oxide or nitride of a metal or semiconductor or a mixture of them. For example, the activation inhibiting layer may be made of an oxide of W, Ti, Ni, Co, Cu, or Ge or a nitride of Si, Al, or Ge, or a mixture of these.

The method for forming the activation inhibiting layer is not limited to a specific one. For example, the activation inhibiting layer can be formed by a known method such as a vacuum evaporation, sputtering, CVD, scattering, dipping, spinner, or ink-jet method.

(Step 4)

Then, a first gap 5 is formed in the conductive films 4 (FIG. 2C). The gap 5 can be formed by using a patterning method by EB lithography. Alternatively, an FIB (Focused Ion Beam) can be applied to a position in the conductive films 4 where the gap 5 is to be formed, thus providing the gap 5 in the predetermined position in the conductive films 4.

Of course, the gap 5 can be provided in a part of the conductive films 4 by passing a current through the conductive film 4s by the known “energization forming” process. In particular, a current can be passed through the conductive films 4 by applying a voltage across the electrodes 2 and 3.

As a result of step 4, conductive films 4a and 4b are disposed opposite each other in the X-direction with the first gap 5 between them. The conductive films 4a and 4b may be united with each other in a small part.

(Step 5)

Then, an activation process is applied. The activation process can be accomplished for example by applying a bipolar pulse voltage across the electrodes 2 and 3 multiple times in an atmosphere of a gas containing carbon introduced in a vacuum system. That is, the bipolar pulse voltage is applied multiple times across the conductive films 4a and 4b.

As a result of the process, carbon films 6a and 6b can be provided on the substrate 1 from the gas containing carbon in the atmosphere. In particular, carbon films 6a and 6b are deposited on the substrate 1 between the conductive films 4a and 4b and on the conductive films 4a and 4b in the vicinity. That is, the carbon films 6a and 6b are disposed with a gap 7 between them.

The gas containing carbon may be an organic material gas. The organic material may be an aliphatic hydrocarbon such as alkane, alkene, or alkyne, an aromatic hydrocarbon, an alcohol, an aldehyde, a ketone, an amine, or an organic acid such as phenol, carvone, or sulfonic acid. In particular, the organic material may be a saturated hydrocarbon that is expressed by the composition formula CₙH₂ₙ₊₂ such as methane, ethane, or propane or an unsaturated hydrocarbon that is expressed by the composition formula CₙH₂ₙ such as ethylene or propylene. Alternatively, the organic material may be benzene, toluene, methanol, ethanol, formaldehyde, acetaldehyde, acetone, methyl ethyl ketone, methylamine, ethyl amine, phenol, formic acid, acetic acid, or propionic acid. Preferably, tolunitrile is used.

By steps 1 through 5, the electron emitter shown in FIGS. 1A, 1B and 1C can be fabricated.

The fabricated electron emitter is preferably subjected to a “stabilization” process in which the electron emitter is heated in a vacuum, before the electron emitter is driven (before an electron beam is applied to an image formation member if the electron emitter is used in an image display apparatus).

It is desirable to perform the stabilization process to remove excessive carbon and an organic material attached to the surface of the substrate 1 or other places during the activation process described above or other process.

In particular, it is desirable to exhaust excessive carbon and organic materials in a vacuum system. It is desirable that organic materials in the vacuum system be removed to a minimum. An organic material is preferably reduced to a partial pressure of less than or equal to 1×10⁻⁸ Pa. The pressure of the entire gas in the vacuum chamber including other materials beside organic materials is preferably less than or equal to 3×10⁻⁶ Pa.

It is desirable that the atmosphere used for the stabilization process described above be maintained and used for subsequently driving the electron emitter. However, the atmosphere for driving the electron emitter is not limited to this. Sufficiently stable properties can be retained by sufficiently reducing the amount of organic materials, even if the pressure somewhat rises.

As a result of the process described above, an electron emitter according to the present invention can be formed.

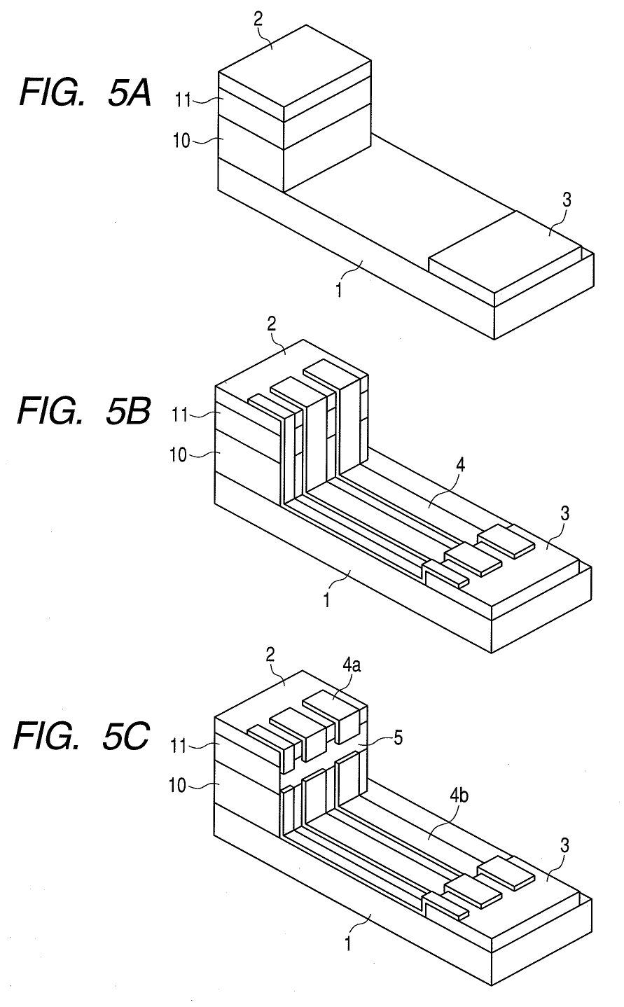

The electron emitter shown in FIGS. 4A, 4B and 4C can be fabricated as described below, for example. The example will be described with reference to FIGS. 5A, 5B and 5C.

A layer of the material of the high thermal conductive layer 10 and a layer of the material of the activation accelerating layer 11 are formed in this order on the substrate 1 described in step 1. These layers can be deposited on the substrate 1 by a method such as vacuum evaporation, sputtering, or CVD. Then, a layer of the material of electrodes 2, 3 is deposited on the material layer of the activation accelerating layer 11 by a method such as vacuum evaporation, sputtering, or CVD.

The material of the activation accelerating layer 11 is preferably SiO₂. A material having a higher thermal conductivity than that of the activation accelerating layer 11 is chosen as the material of the high thermal conductive layer 10. In particular, the high thermal conductive layer 10 may be made of silicon nitride, alumina, aluminum nitride, tantalum pentoxide, or titanium oxide.

Then, a known patterning method such as photolithography is used to form a step-shaped multilayer on a part of the surface of the substrate 1.

An electrode 3 is then formed on the substrate 1 (FIG. 5A).

Conductive films 4 are formed in such a manner that the conductive films 4 cover a side of the multilayer and interconnect the electrodes 2 and 3 in the same way described in the step 2 (FIG. 5B).

The same steps as steps 3 and 4 described above are performed to form conductive films 4a, 4b (FIG. 5C). Finally, step 5 described above is performed to complete the electron emitter shown in FIGS. 4A, 4B and 4C.

The methods for fabricating the electron emitter described above are illustrative only. The first to third embodiments described above are not limited to electron emitters fabricated by these fabrication methods.

An exemplary application of an electron emitter given in the first to third embodiments will be described below.

An electron source is formed by arranging multiple electron emitters of the present invention on a substrate. The electron source can be used to fabricate an image display apparatus such as a flat-panel television display. In particular, a first substrate on which multiple electron emitters of the present invention are arranged is opposed to a second substrate on which an image display member that faces the electron emitters and is irradiated with electrons emitted from the electron emitters is disposed.

The electron emitters on the substrate may be arranged in a matrix, for example.

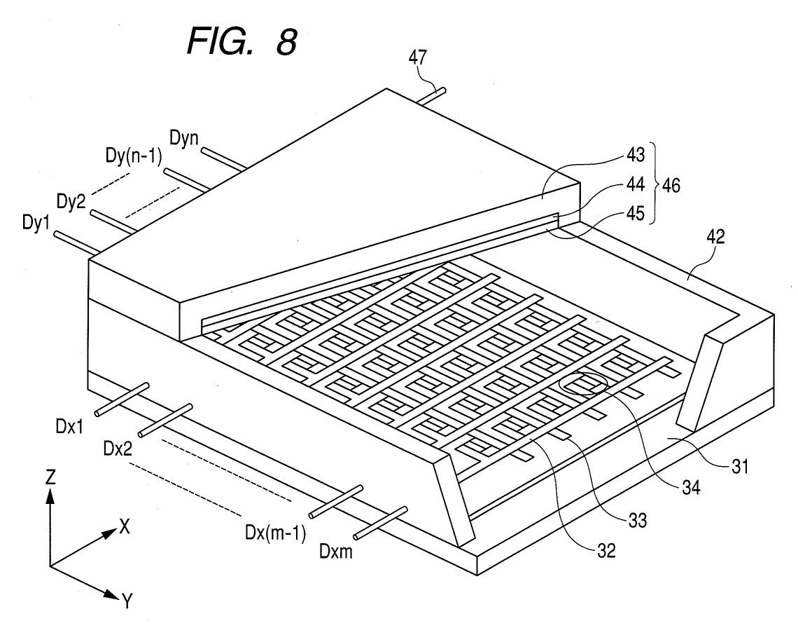

An example of an electron source and an image display apparatus using an electron source substrate on which electron emitters are arranged in a matrix stated above will be described with reference to FIG. 8. FIG. 8 is a cutaway diagram illustrating a basic configuration of a display panel that constitutes an image display apparatus.

In FIG. 8, multiple electron emitters 34 of the present invention are arranged in a matrix on an electron source substrate (rear plate, or first substrate) 31. A face plate (second substrate) 46 includes a transparent substrate 43 made of a material such as glass and having a phosphor coating 44 and a metal back 45 formed in its inner surface. A support frame 42 is disposed between the face plate 46 and the rear plate 31. The rear plate 31, the support frame 42, and the face plate 46 are tightly affixed to each other with an adhesive such as frit glass or indium applied to the junctions between them. The resulting sealed structure forms an enclosure.

Supporting elements called spacers, not shown, can be provided between the face plate 46 and the rear plate 31 as required to form an enclosure having a sufficient strength against atmospheric pressure.

The electron emitters 34 in the enclosure are connected to an X-direction interconnection line 32 and a Y-direction interconnection line 33. Accordingly, application of a voltage to a desired electron emitter 34 through any of terminals Dx1 to Dxm and Dy1 to Dyn that connect to the electron emitter 34 can cause the electron emitter 34 to emit electrons. In doing so, a voltage between or equal to 5 kV and 30 kV, preferably between or equal to 10 kV and 25 kV is applied to the metal back 45 through a high voltage terminal 47. This voltage causes electrons emitted from the selected electron emitter to pass through the metal back 45 and strike the phosphor coating 44. This excites and causes the phosphor 52 to emit light, thereby displaying an image.

### EXAMPLES

The present invention will be described in further detail with respect to examples.

### Example 1

In Example 1, the electron emitters described with respect to the first embodiment were fabricated by following the process shown in FIGS. 2A, 2B and 2C. The configuration of the electron emitter in Example 1 was the same as that shown in FIGS. 1A, 1B and 1C.

(Step-a)

First, sputtering was used to deposit Ti to a thickness of 5 nm on a cleaned quartz substrate 1 and then pt to a thickness of 40 nm on the Ti. Then, photolithography was used to form electrodes 2, 3 on the substrate 1 by patterning. Two groups of nine such elements were formed. The distance L1 between electrodes 2 and 3 in each element in one group was 20 μm and the distance between electrodes 2 and 3 in each element in the other group was 100 μm. The width W2 of the each electrode 2, 3 (see FIG. 1A) was 500 μm (FIG. 2A).

(Step-b)

Then, an organopalladium compound solution was applied to each substrate 1 by spin-coating and then heating and baking was applied. As a result, a conductive film 4 containing Pd as the main component was formed. Then, the conductive film 4 was patterned by photolithography with a stepper to form multiple electrically independent conductive films 4 so as to interconnect the electrodes 2 and 3 (FIG. 2B). Different conditions were used for the nine elements in each of the two groups formed in step-a so that the independent conductive films 4 had different widths W1 of 200 nm, 1 μm, 3 μm, 3.6 μm, 4 μm, 18 μm, 20 μm, 60 μm and 180 μm.

The distance W4 between neighboring conductive films 4 was equal to width W1. The net overall width W3 of the conductive films 4 was 180 μm in all elements. Accordingly, the number of the independent conductive films of each electron emitter was 18/(2×W1).

The conductive film 4 formed had a sheet resistance Rs of 1×10⁴Ω/□ and was 10 nm thick.

(Step-c)

Then, a layer of a mixture of W (tungsten) and GeN (germanium nitride) was formed on each substrate 1 as an activation inhibiting layer. The mixture layer formed was 10 nm thick and has a sheet resistance Rs of 2×10¹⁰Ω/□.

(Step-d)

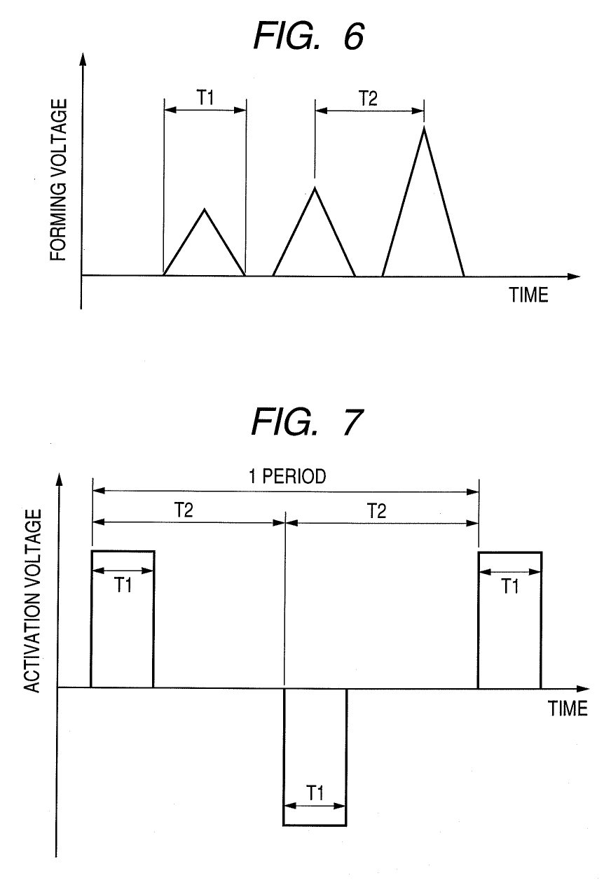

Each substrate 1 was placed in a vacuum system and the vacuum system is evacuated with a vacuum pump until the degree of vacuum in the system reaches 1×10⁻⁶ Pa. Then, a voltage Vf was applied across the electrodes 2 and 3 and the forming process was performed to form a gap 5 in the conductive film 4, thereby forming conductive films 4a, 4b (FIG. 2C). The voltage waveform in the forming process is shown in FIG. 6. In the example, T1 in FIG. 6 is 1 msec and T2 is 16.7 msec. The crest value of the triangular wave was increased with a 0.1 V step to perform the forming process. A resistance measurement pulse at a voltage of 0.1 V was intermittently applied across the electrodes 2 and 3 to measure the resistance during the forming process. The forming process was ended when the value measured with the resistance measurement pulse reached approximately 1 MΩ or greater.

(Step-e)

The activation process was performed next. In particular, tolunitrile was introduced in the vacuum system. Then, a pulse voltage having a waveform shown in FIG. 7 was applied across the electrodes 2 and 3 with a maximum voltage of ±20 V, time T1 of 1 msec and time T2 of 10 msec. After starting the activation process, a check was made to see that the element current If started to gradually increase. Then, the application of the voltage was stopped to end the activation process. As a result, carbon films 6a and 6b were formed.

In this way, the electron emitters were formed.

(Step-f)

Then, a stabilization process was applied to each electron emitter. In particular, the vacuum system and electron emitters were heated by a heater and were maintained at approximately 25 degrees Celsius while evacuating the vacuum system. After a lapse of 20 hours, the heating by the heater was stopped to decrease the temperature in the vacuum system to room temperature, at which the pressure in the vacuum system was approximately 1×10⁻⁸ Pa.

Each electron emitter was then driven in a practical manner and emission current Ie was measured over a long period of time. In practical driving, the distance H between the anode electrode and the electron emitter is 2 mm. An electric potential of 5 kV was applied to the anode electrode from a high-voltage source and a rectangular pulse voltage with a crest value of 17 V, pulse width of 100 μs, and frequency of 60 Hz was applied across the electrodes 2 and 3 of each electron emitter.

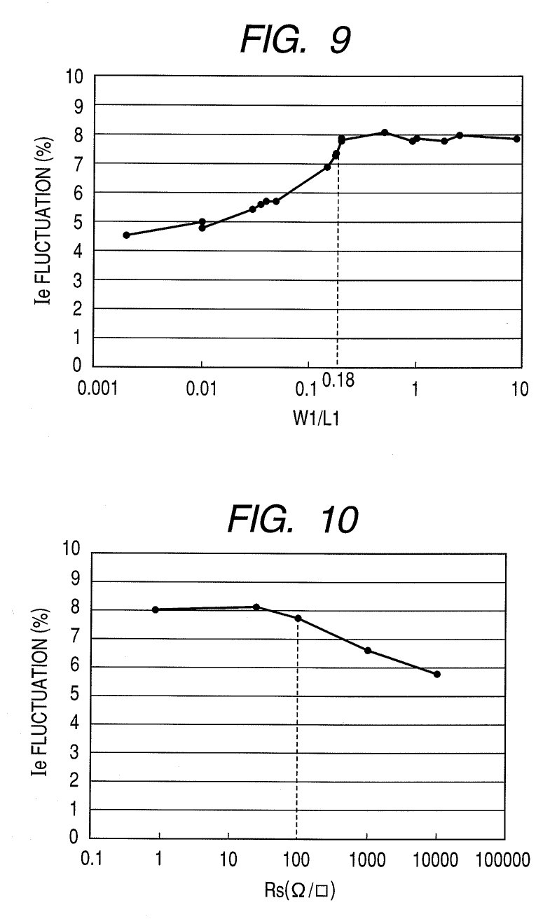

Emission current Ie of each electron emitter of the embodiment was measured. Fluctuations in emission current Ie of all electron emitters were measured multiple times at the same time intervals. Values of fluctuations in emission current Ie were obtained by calculating (standard deviation/mean value×100(%)) of the multiple pieces of measured data. Table 1 below shows the values of fluctuations in emission current Ie of the electron emitters. FIG. 9 shows a graph of the relationship between fluctuation in emission current Ie and W1/L1.

TABLE 1

| L1 | W1 | W1/L1 | Ie fluctuation |
|---|---|---|---|
| 20 μm | 200 nm | 0.01 | 4.8% |
| | 1 μm | 0.05 | 5.7% |
| | 3 μm | 0.15 | 6.9% |
| | 3.6 μm | 0.18 | 7.3% |
| | 4 μm | 0.2 | 7.8% |
| | 18 μm | 0.9 | 7.8% |
| | 20 μm | 1 | 7.9% |
| | 60 μm | 3 | 8.0% |
| | 180 μm | 9 | 7.9% |
| 100 μm | 200 nm | 0.002 | 4.5% |
| | 1 μm | 0.01 | 5.0% |
| | 3 μm | 0.03 | 5.4% |
| | 3.6 μm | 0.036 | 5.6% |
| | 4 μm | 0.04 | 5.7% |
| | 18 μm | 0.18 | 7.4% |
| | 20 μm | 0.2 | 7.9% |
| | 60 μm | 0.6 | 8.1% |
| | 180 μm | 1.8 | 7.8% |

It can be seen from Table 1 and FIG. 9 that the emission current Ie fluctuation value starts to decrease at the point where W1/L1 is 0.18.

After emission current Ie was measured, each electron emitter was observed under a scanning electron microscope. The observation showed no short circuit between adjacent conductive films 4a and 4b by the carbon films 6a, 6b in all electron emitters.

### Example 2

In Example 2, the sheet resistance Rs of the conductive film 4 in the electron emitters described with respect to the first embodiment was varied. The basic configuration of the electron emitters of Example 2 is the same as that in FIGS. 1A, 1B and 1C.

(Step-a)

Five elements are formed in the same way as in step-a of Example 1. The distance L1 between electrodes 2 and 3 was 20 μm and the width W2 of each electrode 2, 3 (see FIG. 1A) was 500 μm (FIG. 2A).

(Step-b)

Then, an organopalladium compound solution was applied to each substrate 1 by spin-coating and heating and baking was applied. The concentration of the organopalladium compound solution and the number of spins during the application were adjusted to form a film with a thickness of 10 nm on one of two substrates and a film with a thickness of 100 nm on the other. After the formation, the sheet resistance Rs of the 10-nm- and 100-nm-thick conductive films 4 were 1×10⁴Ω/□ and 1×10³Ω/□, respectively.

By using sputtering, a thin ITO (containing 95 wt % of In₂O₃ and 5 wt % of SnO₂) film was formed to a thickness of 20 nm on one of two other substrates subjected to step-a and to a thickness of 100 nm on the other. The sheet resistances Rs of the 20-nm- and 100-nm-thick conductive films 4 formed were 100Ω/□ and 25Ω/□, respectively.

A thin Au film was formed on the remaining substrate 1 subjected to step-a by electron beam evaporation to a thickness of 100 nm. The sheet resistance Rs of the conductive film 4 formed was 0.8Ω/□.

Thus, the conductive films 4 having different sheet resistances Rs were formed on the individual substrates.

Then, the conductive film 4 was patterned by photolithography with a stepper to form multiple electrically independent conductive films 4 so as to interconnect the electrodes 2 and 3 (FIG. 2B). The independent conductive films 4 were formed on each of the five elements having different conductive film 4 sheet resistances Rs to a width W1 of 1 μm (W1/L1=0.05).

The distance W4 between adjacent conductive films 4 was 1 μm. The net overall width W3 of the conductive films 4 was 100 μm. Accordingly, the number of the independent conductive films 4 is 100 μm/(2×1 μm)=50.

The same steps as step-c through step-f described with respect to Example 1 were applied to each substrate 1 subjected to step-b to complete electron emitters.

As in Example 1, emission current Ie of the electron emitters of Example 2 was measured. Fluctuations in emission current Ie of all electron emitters were measured multiple times at the same time intervals. Values of fluctuations in emission current Ie were obtained by calculating (standard deviation/mean value×100(%)) of the multiple pieces of measured data. Table 2 below shows the values of fluctuations in emission current Ie of the electron emitters. FIG. 10 shows a graph of the relationship between fluctuation in emission current Ie and the sheet resistance Rs of the conductive film 4.

TABLE 2

| | Rs | | | | |
|---|---|---|---|---|---|
| | 0.8 Ω/□ | 25 Ω/□ | 100 Ω/□ | 1 × 10³ Ω/□ | 1 × 10⁴ Ω/□ |
| Ie | 8.0% | 8.1% | 7.7% | 6.6% | 5.8% |
| fluctuation | | | | | |

It can be seen from Table 2 and FIG. 10 that the emission current Ie value decreases where the sheet resistance Rs of the conductive film 4 is equal to or greater than 100Ω/□.

After emission current Ie was measured, each electron emitter was observed under a scanning electron microscope. The observation showed no short circuit between adjacent conductive films 4a and 4b by carbon films 6a, 6b in all electron emitters.

### Example 3

In Example 3, electron emitters described with respect to the second embodiment were fabricated. The configuration of the electron emitter of Example 3 is the same as that in FIGS. 3A, 3B and 3C.

(Step-a)

Two groups of nine elements were formed in the same way as in step-a of Example 1. The distance L1 between electrodes 2 and 3 in each element in one group was 40 μm and the distance between electrodes 2 and 3 in each element in the other group was 120 μm. The width W2 of each electrode 2, 3 was 500 μm.

(Step-b)

Then, an organopalladium compound solution was applied to each substrate 1 by spin-coating and heating and baking was applied. As a result, a conductive film 4 containing Pd as the main component was formed. Then, the conductive film 4 was patterned by photolithography with a stepper to form conductive films 4 having multiple openings in such a manner that the electrodes 2 and 3 are interconnected.

The length L2 of the conductive film 4 between openings in the X-direction was set to 20 μm for the elements with a distance L1 between the electrodes 2 and 3 of 40 μm and set to 100 μm for the elements with L1 of 120 μm.

Different conditions were used for the nine elements in each of the two groups with length L2 so that the conductive film 4 between openings had different widths W1 of 200 nm, 1 μm, 3 μm, 3.6 μm, 4 μm, 18 μm, 20 μm, 60 μm and 180 μm.

The distance W4 between neighboring conductive films 4 was equal to width W1. The net overall width W3 of conductive films 4 was 180 μm in all elements. Accordingly, the number of the conductive films 4, each being between openings, of each electron emitter was 180/(2×W1).

The conductive film 4 formed had a sheet resistance Rs of 1×10⁴Ω/□ and was 10 nm thick.

The same steps as step-c through step-f described with respect to Example 1 were applied to the substrates 1 subjected to step-b to complete electron emitters.

As in Example 1, emission current Ie of the electron emitters of Example 3 was measured. Fluctuations in emission current Ie of all electron emitters were measured multiple times at the same time intervals. Values of fluctuations in emission current Ie were obtained by calculating (standard deviation/mean value×100(%)) of the multiple pieces of measured data. The results of the measurement were approximately the same as those of Example 1.

### Example 4

In Example 4, the sheet resistance Rs of the conductive film 4 in the electron emitters described with respect to the second embodiment was varied. The basic configuration of the electron emitter of Example 4 is the same as that in FIGS. 3A, 3B and 3C.

(Step-a)

Five elements were formed in the same way as in step-a of Example 1. The distance L1 between electrodes 2 and 3 was 40 μm and the width W2 of each electrode 2, 3 (see FIG. 3A) was 500 μm.

(Step-b)

Then, an organopalladium compound solution was applied to two of substrates 1 subjected to step-a by spin-coating and heating and baking was performed. The concentration of the organopalladium compound solution and the number of spins during the application were adjusted to form a film with a thickness of 10 nm on one of the two substrates and a film with a thickness of 100 nm on the other. After the formation, the sheet resistance Rs of the 10-nm- and 100-nm-thick conductive films 4 were 1×10⁴Ω/□ and 1×10³Ω/□, respectively.

By using sputtering, a thin ITO (containing 95 wt % of In₂O₃ and 5 wt % of SnO₂) film was formed on each of two other substrates 1 subjected to step-a, to a thickness of 20 nm on one substrate and to a thickness of 100 nm on the other. The sheet resistances Rs of the 20-nm- and 100-nm-thick conductive films 4 formed were 100Ω/□ and 25Ω/□, respectively.

A thin Au film was formed on the remaining substrate 1 subjected to step-a by electron beam evaporation to a thickness of 100 nm. The sheet resistance Rs of the conductive film 4 formed was 0.8Ω/□.

Thus, the conductive films 4 having different sheet resistances Rs were formed on the individual substrates.

Then, the conductive film 4 was patterned by photolithography with a stepper to form conductive films 4 having multiple openings in such a manner that the electrodes 2 and 3 are interconnected as shown in FIG. 3A.

The length L2 of the conductive film 4 between openings in the X-direction was set to 20 μm.

The conductive film 4 between openings was formed on each of five elements having different conductive film 4 sheet resistances Rs to a width W1 of 1 μm (W1/L2=0.05). The distance W4 between adjacent conductive films 4 was 1 μm. The net overall width W3 of the conductive films 4 was 100 μm. Accordingly, the number of the conductive films 4, each being between openings, of each element was 100 μm/(2×1 μm)=50.

The same steps as step-c through step-f described with respect to Example 1 were applied to the substrates 1 subjected to step-b to complete electron emitters.

As in Example 1, emission current Ie of the electron emitters of Example 4 was measured. Fluctuations in emission current Ie of all electron emitters were measured multiple times at the same time intervals. Values of fluctuations in emission current Ie were obtained by calculating (standard deviation/mean value×100(%)) of the multiple pieces of measured data. The results of the measurement were approximately the same as those of Example 2.

### Example 5

In Example 5, the electron emitters described with respect to the third embodiment were fabricated by following the process in FIGS. 5A, 5B and 5C. The configuration of the electron emitter of Example 5 is the same as that in FIGS. 4A, 4B and 4C.

(Step-a)

First, 18 cleaned quartz substrates were provided. Then, Si₃N₄ was deposited on each of the substrates 1 as the material of a high thermal conductive layer 10. The layer of Si₃N₄ was formed by plasma CVD. At the same time, the same material was deposited on another substrate used for measuring thermal conductivity and the thermal conductivity of the substrate was measured at room temperature and found to be 25 W/m·K.

Then, silicon oxide (SiO₂) was deposited by plasma CVD on all substrates 1 as the material of an activation accelerating layer 11. At the same time, SiO₂ was deposited on another substrate used for measuring thermal conductivity and the thermal conductivity of the substrate was measured at room temperature and found to be 1.4 W/m·K.

On the activation accelerating layer 11, Ti and Pt are deposited to a thickness of 5 nm and 40 nm, respectively, as the materials of an electrode 2.

Then, spin-coating of a photoresist and exposure and development of a mask pattern were performed. Dry etching was performed to form a multilayer including the high thermal conductivity layer 10 and the activation accelerating layer 11 and form an electrode 3 on the multilayer.

Then, the photoresist was stripped off and spin-coating of a photoresist and exposure and development of a mask pattern were performed again to form a photoresist having an opening corresponding to the pattern of the electrode 3. Then, Ti with a thickness of 5 nm and Pt with a thickness of 40 nm were deposited in the opening in this order. The photoresist was then lifted off to complete the electrode 3 (FIG. 5A).

The width W2 of the electrodes 3 and 2 was 500 μm. The high thermal conductivity layer 10 was 500 nm thick and the activation accelerating layer 11 was 50 nm thick. Accordingly, L4 was 550 nm.

Two groups of nine substrates 1 were fabricated. The distance (L3+L4) between electrodes 2 and 3 in each substrate 1 in one group was 20 μm and that in the other group was 100 μm.

(Step-b)

Then, an organopalladium compound solution was applied to each substrate 1 subjected to step-a by spin-coating and heating and baking is applied. As a result, a conductive film 4 containing Pd as the main component was formed. Then, the conductive film 4 was patterned by photolithography with a stepper to form multiple electrically independent conductive films 4 so as to interconnect the electrodes 2 and 3 (FIG. 5B). Different conditions were used for the nine elements in each of the two groups formed in step-a so that the independent conductive films 4 had different widths W1 of 200 nm, 1 μm, 3 μm, 3.6 μm, 4 μm, 18 μm, 20 μm, 60 μm and 180 μm.

The distance W4 between neighboring conductive films 4 was equal to width W1. The net overall width W3 of conductive films 4 was 180 μm in all elements. Accordingly, the number of the independent conductive films of each electron emitter was 180/(2×W1).

The conductive film 4 formed had a sheet resistance Rs of 1×10⁴Ω/□ and was 10 nm thick.

Then, the same steps as step-c through step-f were performed to complete electron emitters.

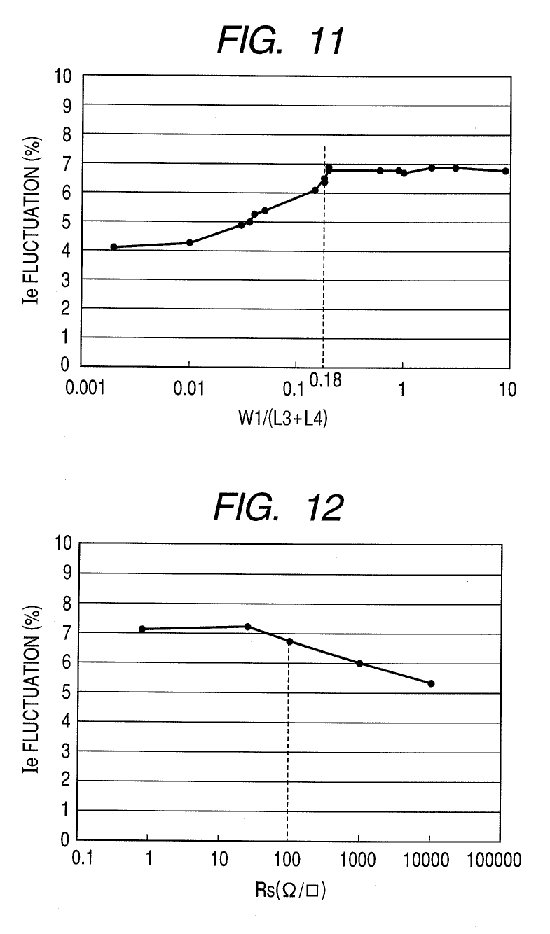

As in Example 1, emission current Ie of the electron emitters of the embodiment was measured. Fluctuations in emission current Ie of all electron emitters were measured multiple times at the same time intervals. Values of fluctuations in emission current Ie were obtained by calculating (standard deviation/mean value×100(%)) of the multiple pieces of measured data. Table 3 below shows the values of fluctuations in emission current Ie of the electron emitters. FIG. 11 shows a graph of the relationship between fluctuation in emission current Ie and W1/(L3+L4).

TABLE 3

| L3 + L4 | W1 | W1/L3 + L4 | Ie fluctuation |
|---|---|---|---|
| 20 μm | 200 nm | 0.01 | 4.3% |
| | 1 μm | 0.05 | 5.4% |
| | 3 μm | 0.15 | 6.1% |
| | 3.6 μm | 0.18 | 6.5% |
| | 4 μm | 0.2 | 6.8% |
| | 18 μm | 0.9 | 6.8% |
| | 20 μm | 1 | 6.7% |
| | 60 μm | 3 | 6.9% |
| | 180 μm | 9 | 6.8% |
| 100 μm | 200 nm | 0.002 | 4.1% |
| | 1 μm | 0.01 | 4.3% |
| | 3 μm | 0.03 | 4.9% |
| | 3.6 μm | 0.036 | 5.0% |
| | 4 μm | 0.04 | 5.3% |
| | 18 μm | 0.18 | 6.4% |
| | 20 μm | 0.2 | 6.9% |
| | 60 μm | 0.6 | 6.8% |
| | 180 μm | 1.8 | 6.9% |

It can be seen from Table 3 and FIG. 11 that the emission current Ie fluctuation value decreases where W1/(L3+L4) is 0.18 or smaller.

After emission current Ie was measured, each electron emitter was observed under a scanning electron microscope. The observation showed no short circuit between adjacent conductive films 4a and 4b by carbon films 6a, 6b in all electron emitters.

### Example 6

In Example 6, the sheet resistance Rs of the conductive film 4 in the electron emitters described with respect to the third embodiment was varied. The basic configuration of the electron emitter of Example 6 is the same as that in FIGS. 4A, 4B and 4C.

(Step-a)

Five substrates 1 having the structure shown in FIG. 5A were provided in the same step as step-a of Example 5. The width W2 of electrodes 2 and 3 was 500 μm. The high thermal conductive layer 10 was 500 nm thick and the activation accelerating layer 11 was 50 nm thick. The distance (L3+L4) between the electrodes 2 and 3 was 20 μm.

(Step-b)

Then, an organopalladium compound solution was applied to two of substrates 1 subjected to step-a by spin-coating and heating and baking was applied. The concentration of the organopalladium compound solution and the number of spins during the application were adjusted to form a film with a thickness of 10 nm on one of the two substrates and a film with a thickness of 100 nm on the other. After the formation, the sheet resistance Rs of the 10-nm- and 100-nm-thick conductive films 4 were 1×10⁴Ω/□ and 1×10³Ω/□, respectively.

By using sputtering, a thin ITO (containing 95 wt % of In₂O₃ and 5 wt % of SnO₂) film was formed on each of two other substrates 1 subjected to step-a, to a thickness of 20 nm on one substrate and to a thickness of 100 nm on the other. The sheet resistances Rs of the 20-nm- and 100-nm-thick conductive films 4 formed were 100Ω/□ and 25Ω/□, respectively.

A thin Au film was formed on the remaining substrate 1 subjected to step-a by electron beam evaporation to a thickness of 100 nm. The sheet resistance Rs of the conductive film 4 formed was 0.8Ω/□.

Thus, the conductive films 4 having different sheet resistances Rs were formed on the individual substrates.

Then, the conductive film 4 was patterned by photolithography with a stepper to form multiple electrically independent conductive films 4 so as to interconnect the electrodes 2 and 3 (FIG. 5B). The independent conductive films 4 were formed on each of the five elements having different conductive film 4 sheet resistances Rs to a width W1 of 1 μm (W1/(L3+L4)=0.05).

The distance W4 between adjacent conductive films 4 was 1 μm. The net overall width W3 of the conductive films 4 was 100 μm. Accordingly, the number of the independent conductive films 4 was 100 μm/(2×1 μm)=50.

The same steps as step-c through step-f described with respect to Example 1 were applied to substrates 1 subjected to step-b to complete electron emitters.

As in Example 1, emission current Ie of the electron emitters of Example 6 was measured. Fluctuations in emission current Ie of all electron emitters were measured multiple times at the same time intervals. Values of fluctuations in emission current Ie were obtained by calculating (standard deviation/mean value×100(%)) of the multiple pieces of measured data. Table 4 below shows the values of fluctuations in emission current Ie of the electron emitters. FIG. 12 shows a graph of the relationship between fluctuation in emission current Ie and the sheet resistance Rs of the conductive film 4.

TABLE 4

| | Rs | | | | |
|---|---|---|---|---|---|
| | 0.8 Ω/□ | 25 Ω/□ | 100 Ω/□ | 1 × 10³ Ω/□ | 1 × 10⁴ Ω/□ |
| Ie | 7.1% | 7.2% | 6.7% | 6.0% | 5.3% |
| fluctuation | | | | | |

It can be seen from Table 4 and FIG. 12 that the emission current Ie fluctuation value starts to decrease at the point where the sheet resistance Rs of the conductive film 4 is equal to 100Ω/□.

After emission current Ie was measured, each electron emitter was observed under a scanning electron microscope. The observation showed no short circuit between adjacent conductive films 4a and 4b by carbon films 6a, 6b in all electron emitters.

### Example 7

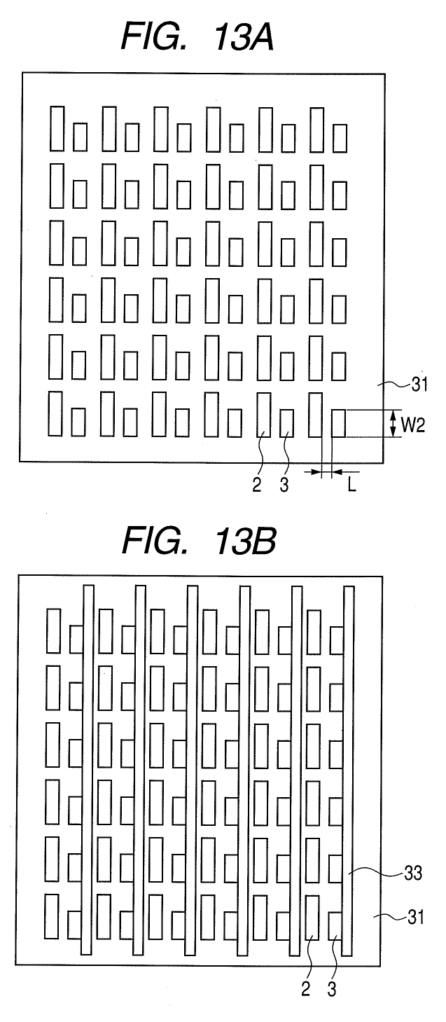

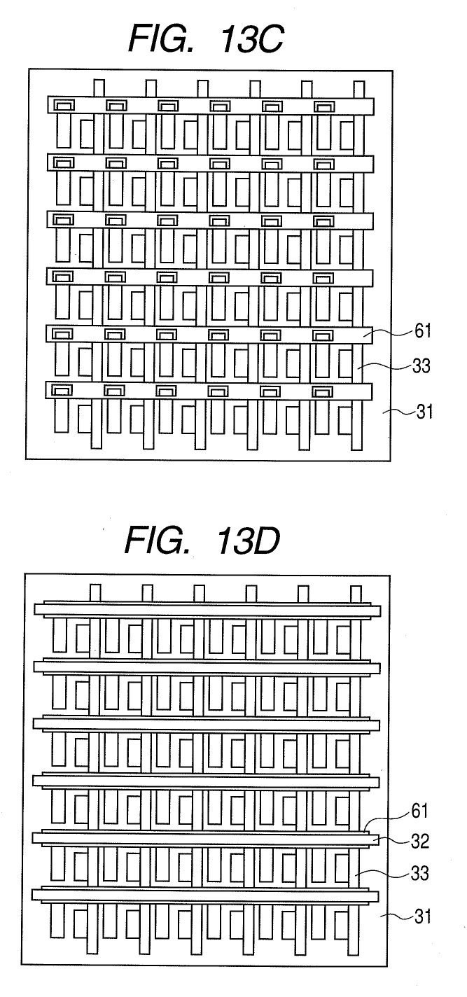

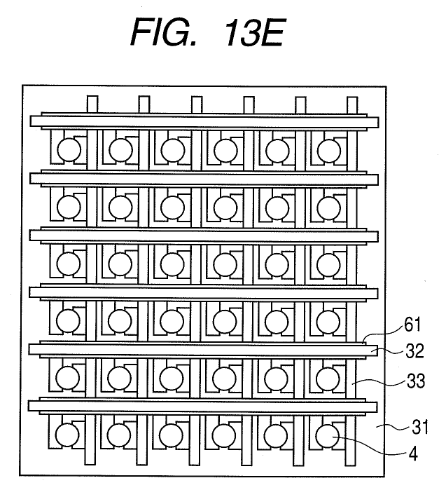

In Example 7, many electron emitters fabricated by the same fabrication method as used for the electron emitters in Example 1 described above were arranged in a matrix on a substrate to form an electron source. The electron source was used to fabricate an image display apparatus shown in FIG. 8. FIGS. 13A, 13B, 13C, 13D and 13E illustrate the fabrication process.

<Electrode Fabrication Step>

First, many electrodes 2, 3 were formed on a substrate 31 (FIG. 13A). In particular, multilayer film of layers of titanium Ti and platinum Pt was formed on the substrate 31 to a thickness of 40 nm and was patterned by photolithography to form the electrodes 2, 3. The distance L1 between the electrodes 2 and 3 was 20 μm and the width of the electrodes 2, 3 was 200 μm.

<Y-Direction Interconnection Line Forming Step>

Then, Y-direction interconnection lines 33 mainly containing silver were formed so as to connect to the electrodes 3 as shown in FIG. 13B. The Y-direction interconnection lines 33 function as lines to which a modulation signal is applied.

<Insulating Layer Forming Step>

Then, insulating layers 61 made of silicon oxide were disposed as shown in FIG. 13C in order to insulate the Y-direction interconnection lines 33 from X-direction interconnection lines 32 formed in the next step. The insulating layers 61 are disposed under the X-direction interconnection lines 32, which will be described later, and are over and cover the Y-direction interconnection lines 33 formed earlier. Contact holes are provided in portions of the insulating layers 61 so that the X-direction interconnection lines 32 and the electrodes 2 can be electrically interconnected.

<X-Direction Interconnection Line Forming Step>

The X-direction interconnection lines 32 mainly containing silver were formed over the insulating layers 61 formed earlier, as shown in FIG. 13D. The X-direction interconnection lines 32 intersect the Y-direction interconnection lines 33 with the insulating layers 61 between them and are connected to the electrodes 2 through the contact holes in the insulating layers 61. The X-direction interconnection lines 32 function as lines to which a scan signal is applied. In this way, the substrate 31 having a matrix lines was completed.

<Conductive Film Forming Step>

Ink-jet printing was used to form a conductive film 4 between the electrodes 2 and 3 on the substrate 31 on which the matrix lines were formed (FIG. 13E). In this example, an organopalladium complex solution was used as the ink for the ink-jet printing. The organopalladium complex solution was applied so as to interconnect the electrodes 2 and 3. Then, the substrate 31 was heated and baked in air to form a conductive film 4 of palladium oxide (PdO).

Then, FIB was applied to the conductive film 4 to form 50 electrically independent conductive films 4 were formed for all electron emitters. The width W1 of each conductive film 4 was 1 μm and the distance W4 between adjacent conductive films 4 was 1 μm.

Then, a gap 5 was formed in each conductive film 4 in the same way as in Example 1 and the activation process was performed. The waveform of a voltage applied to each unit during the activation process is as described with respect to the electron emitter fabrication method of Example 1.

As a result of the process described above, the substrate 31 having an electron source (multiple electron emitters) disposed was formed.

Then, a face plate 46 including a glass substrate 43 having a phosphor coating 44 and a metal back 45 layered on its internal surface was placed 2 mm above the substrate 31 through a support frame 42 as shown in FIG. 8.

The face plate 46, the support frame 42 and the substrate 31 are tightly affixed together by applying indium (In), which is a low-melting metal, to the junctions between them, and heating and then cooling the indium. The affixing and sealing were performed at a time in a vacuum chamber without using an evacuation tube.

The phosphor coating 44, which is an image formation member, was a striped phosphor coating in this example for color display. First, light absorbers were formed at desired spacings. Then, the phosphor coating 44 was formed by applying color phosphors between the light absorbers using a slurry technique. The light absorbers were made of a commonly used material containing graphite as the main component.

The metal back 45 made of aluminum was provided on the inner surface (on the electron emitter side) of the phosphor coating 44. The metal back 45 was formed by depositing Al on the inner surface of the phosphor coating 44 by vacuum deposition.

A desired electron emitter of the image display apparatus thus completed was selected through an X-direction interconnection line 32 and a Y-direction interconnection line 33 and a pulse voltage of 17 V was applied to the electron emitter. At the same time, a voltage of 10 kV was applied to the metal back 45 through a high-voltage terminal Hv. This experiment showed that bright high-quality images can be displayed with minimum brightness unevenness and variations for a long period of time.

The embodiments and examples described above are illustrative only and various variations of the materials, sizes and other specifics described above are encompassed by the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-126627, filed May 14, 2008, which is hereby incorporated by reference herein in its entirety.

What is claimed is:

1. An electron emitter comprising:
at least one pair of electrodes formed on an insulating substrate and a plurality of conductive films formed to interconnect the electrodes, wherein each of the conductive films has a gap between the electrodes, the distance L1 between the electrodes and the width W1 of the conductive film in the direction orthogonal to the direction in which the electrodes are opposed to each other are such that W1/L1≦0.18, and the sheet resistance of the conductive film is in the range from 1×10² to 1×10⁷Ω/□.

2. An image display apparatus comprising:
a first substrate on which a plurality of electron emitters according to claim 1 is disposed; and
a second substrate which is opposed to the first substrate and on which an image display member to which electrons emitted from the plurality of electron emitters are irradiated is disposed so as to face the electron emitters.

3. An electron emitter comprising:
at least one pair of electrodes formed on an insulating substrate and a conductive film formed to interconnect the electrodes, wherein
the conductive film has a plurality of openings between the electrodes in the direction orthogonal to the direction in which the electrodes are opposed to each other and has a gap in a region in the conductive film along the direction orthogonal to the direction in which the electrodes are opposed to each other, the region being adjacent to the openings, the length L2 of the conductive film in the region in the direction parallel to the direction in which the electrodes are opposed to each other and the width W1 of the conductive film in the direction orthogonal to the direction in which the electrodes are opposed to each other are such that W1/L2≦0.18, and the sheet resistance of the conductive film is in the range from 1×10² to 1×10⁷Ω/□.

4. An image display apparatus comprising:
a first substrate on which a plurality of electron emitters according to claim 3 is disposed; and
a second substrate which is opposed to the first substrate and on which an image display member to which electrons emitted from the plurality of electron emitters are irradiated is disposed so as to face the electron emitters.
